(19) United States
(12) Patent Application Publication
(10) Pub. No.: US 2006/0155417 A1
(43) Pub. Date: Jul. 13, 2006

(54) Method for grading a series of shoe lasts distributed on a series of sizes starting from a base last and shoe last so obtained

(76) Inventors: Armido Cremaschi, Verolanuova (IT); Flavio Merigo, Mizzole (IT)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/511,552

(22) PCT Filed: Apr. 22, 2003
(86) PCT No.: PCT/EP03/04115

§ 371 Date: Aug. 2, 2005

(30) Foreign Application Priority Data
Apr. 19, 2002 (EP) 02425246.2

(51) Int. Cl. G06F 19/00

(52) U.S. Cl. 700/182; 700/118

(57) ABSTRACT

The invention relates to a new method for developing a series of shoe shapes starting from a base shoe shape provided in a basic footwear size. The method comprises the following steps:
measuring the spatial coordinates (x_{B}, y_{B}, z_{B}) of points on the base shoe shape (2) of basic footwear size using gauges (15) associated with a first computer means (10) on which CAD programs are run;
obtaining, from the spatial coordinates (x_{B}, y_{B}, z_{B}) of points on the base shoe shape (2) of basic footwear size, spatial coordinates (xₙ, yₙ, zₙ) of points on at least another shoe shape in the series, by using predetermined calculation formulae entered to said computer means;
feeding an NC tool machine with said spatial coordinates (xₙ, yₙ, zₙ) of points on at least another shoe shape in the series for the manufacturing thereof; using the information contained in the memory, physically installed in each shoe shape or accessible by means of its code, to design the footwear component parts and properly assembling them at the production stage.

### FIELD OF APPLICATION

The present invention relates to a method for scale manufacturing a series of shoe shapes starting from a base shoe shape provided in a basic footwear size.

The invention also relates to a shoe shape made by the above method.

Particularly but not exclusively, the invention relates to a method applied to the scale manufacturing of a range of footwear articles distributed on a series of different sizes, starting from one base shoe shape provided in a basic footwear size, and the following description is made with reference to this application field fur convenience of illustration only.

### PRIOR ART

As it is well known in this technical field, in order to manufacture footwear in large and very large scales, it is necessary to have shoe shapes previously performed on the basis of a predetermined shoe design and in the several footwear sizes to be manufactured. This shoe design will be hereinafter referred to as the “base shoe shape”.

In the state of the art, each shoe shape is realized by mechanically removing material from a preformed blank of plastics that is obviously provided in a somewhat larger overall size than the finished shoe shape. This machining is carried out, for example, on tool machines known as “Donzelli lathes”, which are equipped with a special measuring head or gauge for reading the shoe design to be produced, and with a number of machining heads, usually four machining heads.

These lathes incorporate a mechanical scaling system, and can produce a full range of right/left footwear sizes from a single base shoe shape which has been realized by a skilled shoe designer or a stylist, for example.

A compound arrangement of gears and levers allows the dimensions of the base shoe shape to be scaled along three Cartesian axes. Basically all such lathes include levers that enable this scaling to be effected on the basis of predetermined mechanisms and cinematic relations, long known in the industry.

It should be noted, however, that this machining procedure does not take into proper account the anatomy and morphology of an evolving human foot, which changes somewhat with both the type and the size of an individual.

Consequently, the shoe design or shoe shape maker is obliged to apply corrections during the machining process, in order to produce a series of shoe shapes that would adhere to the evolution of the foot in an anatomically accurate shape. Such corrective actions are left to the operator's judgement and are bound by the machine limitations. Thus, it is not possible to guarantee the production of accurate copies of a series of shoe shapes that span a range of footwear sizes, maintaining the original style.

In addition, there exist at present a bewildering variety of footwear size systems, and of subjective shoe shape measuring methods, which often leads to a total lack of communication when the info must circulate among a certain number of subjects.

Over the years, for example, footwear manufacturers that had planned their production to suit equipment and systems tailored to their own requirements, due to changes of the manufacturing processes, are now to share their information with outside suppliers of tools, parts, or services that may be using different measurement systems and methods.

This substantial inconsistency of the measurement systems and tooling paradoxically denies the ability to obtain values that are comparable, i.e. to establish the same measurements by the different subjects involved in carrying out the same measurement.

To overcome these shortcomings, it has been common practice to design each component part of a shoe by means of operations that had to be reiterated with progressively finer adjustments, obviously resulting in considerable expenditure of time and resources.

It can be appreciated that the footwear manufacturing process cannot be carried out in parallel steps, but is to go through a succession of serial steps, not to incur the risk of repeating steps because of any changes made downstream, intentionally or unintentionally.

A known prior art solution is disclosed in the European patent No. 0 311 925 concerning a method and apparatus for making shoe lasts by digitizing on the fly a large number of sample points on the outer surface of he model last.

This solution correspond to the preamble of the enclosed claim 1 but fail to teach how to use the digital information so obtained for computing and manufacturing a range of footwear articles distributed on a series of different sizes in accordance with the morphology and anatomy of the human foot.

The underlying technical problem of this invention is to provide a new method for developing a series of shoe shapes, in a range of footwear sizes, with appropriate features to enable shoe shapes to be manufactured, exactly matching the foot morphology and anatomy, while maintaining their likeness to a base shoe shape through the various sizes to be provided. This method also improves simpler footwear designing and manufacturing procedures and lower production costs.

### SUMMARY OF THE INVENTION

The solvent idea of this invention is that of using CAD system and software to gather the spatial coordinates of a base shoe shape and apply them to different footwear sizes of said base shoe shape using parameters that fully emulate, or at least very closely track, the morphological evolution of the human foot. A shoe shape is then made for each footwear size, using a CAM system connected to an NC tool machine. In this way, the shoe shapes can be manufactured in very large scales on traditional machines, substantially as copies of each CAM shoe shape that span the full range of footwear sizes.

From the same CAD data as have been used for the shoe shapes, a set of footwear component parts related to the shoe shapes, such as the insole, toe piece, quarter, heel, can be designed.

By designing the molds intended for molding or pressing such component parts in conformity with the same manufacturing data as have been used for the shoe shapes, component parts that fit true can be obtained, and assembling techniques hitherto impracticable can be used.

Based on this idea, the technical problem is solved by a shoe shape manufacturing method as defined in the attached Claim 1 foll.

The technical problem is further solved by a shoe shape as defined in Claim 18 foll.

The features and advantages of the method and the shoe shape according to this invention will become apparent from the following description of embodiments thereof, given by way of example and not of limitation with reference to the accompanying drawings.

### BRIEF DESCRIPTION OF THE DRAWINGS

FIG. 1 shows a perspective and schematic view of a shoe shape obtained by the method of this invention.

FIG. 2 shows a side view of the shoe shape shown in FIG. 1, and of ancillary items in the forms of a top pad and an insole.

FIG. 3 shows a perspective view of a virtual shoe shape obtained on a computer means using a CAD setting for data gathering, according to the invention.

FIG. 4 shows a side and schematic view of a shoe shape 1 that brings out the shoe shape contour lines and projected length.

FIG. 5 shows a side view of a shoe shape 1, as re-constructed in a CAD setting and with some lines that define the “fit”.

FIGS. 5A, 5B and 5C show side, top and again side views, respectively, of a shoe shape that brings out distance, axes, and reference planes thereof.

FIG. 6 shows a schematic view of a base shoe shape of basic footwear size, as being subjected to an operation of data gathering by a computer means on which CAD software is run, according to the method of this invention.

FIG. 6A shows a detail of the embodiment of FIG. 6.

FIG. 7 shows another perspective view of a virtual shoe shape obtained on a computer means in a CAD setting, with some guidelines brought out which allow a shoe shape and associated footwear component parts to be three-dimensionally re-constructed.

FIG. 8 shows an exploded side view in perspective of the shoe shape of FIG. 1 and some component parts of the corresponding shoe.

FIG. 9A and 9B schematically show an automatic assembly line for manufacturing footwear articles from the shoe shape of this invention.

FIG. 10 schematically shows an apparatus for manipulating the shoe shape of FIG. 1.

FIGS. 11, 12 and 13 are respective schematic views of apparatus for manipulating the shoe shape of FIG. 1 in accordance with the inventive method.

FIGS. 14, 15 and 16 show plots illustrating the qualitative relationships and dimensional ratios along the X, Y and Z axes of the shoe shapes as re-constructed by the inventive method to match varying sizes of footwear intended for child, lady and gentleman use, respectively.

### DETAILED DESCRIPTION

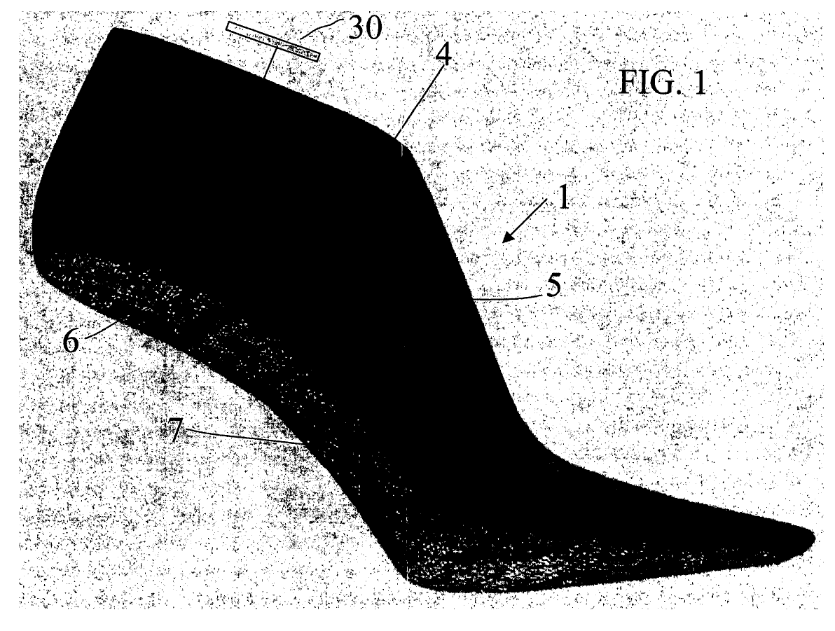

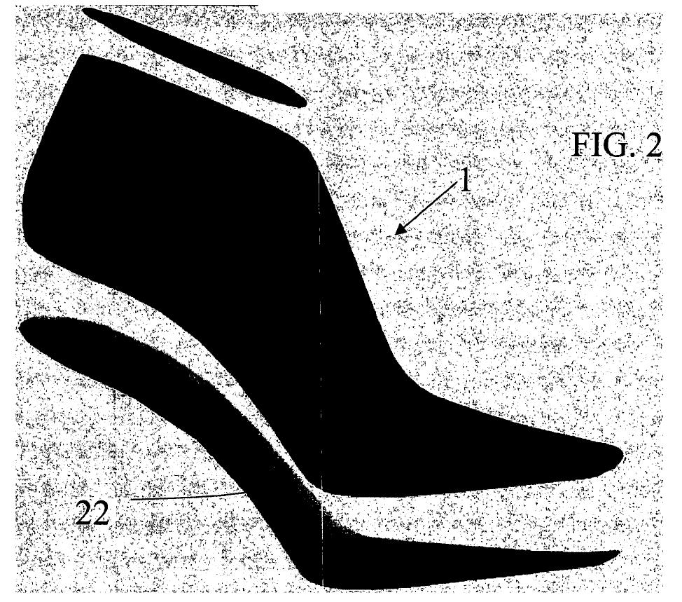

With reference to the drawings, particularly to the embodiment shown in FIG. 1 thereof, a shoe shape is generally shown at 1 in schematic form which has been manufactured in accordance with the manufacturing method of this invention.

The shoe shape 1 differs from shoe shapes manufactured with prior methods in that it matches with the true anatomy and morphology of the foot, and exactly corresponds to a template provided in the form of a base shoe shape 2 spanning a desired range of footwear sizes.

As better explained hereinafter, a base shoe shape of basic footwear size is a shoe shape directed to duplicate an average foot as closely as possible, so that it would fit the widest possible variety of real feet.

As it is well known in this technical field, the shoe shape 1 is a tool used for manufacturing a number of footwear articles of the same type on shoe-making machines, e.g. of the kind of a top pad assembling machine employed to mount the top pad of uppers 12 onto a shoe insole 22. Such machines 20 include a operator position where the shoe shape 1 is centrally supported while the uppers 12 is fitted onto the shoe shape 1 with the insole facing up and the toe end facing the operator.

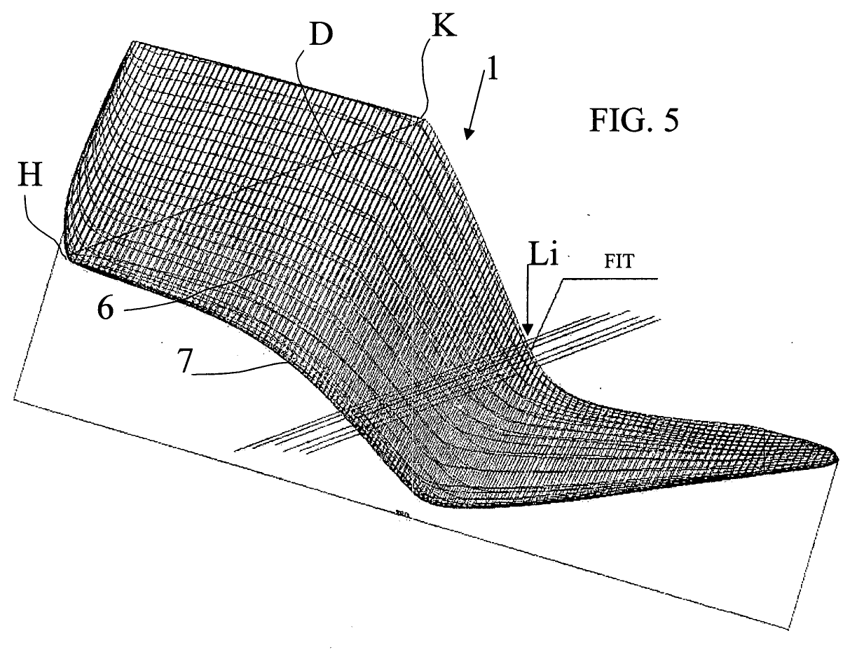

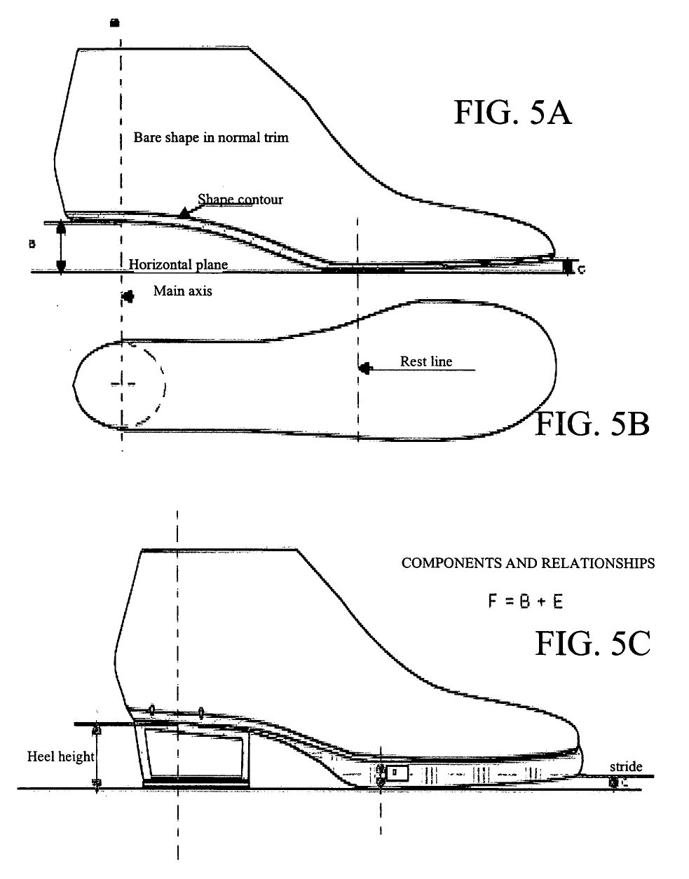

To make all the aspects of this invention more clearly understood, it may be useful to first define certain distances and geometric references used through the remainder of this specification. These references are indicated in FIGS. 5A, 5B and 5C as follows:

Main Axis A: this is a vertical line drawn through the center of a circle inscribed into the rearward portion of the top pad;

Shoe shape Height B: this is the height above the horizontal plane of the point where the main axis A meets the top pad, with the shoe shape/insole assembly in normal trim;

Stride C: this is the height above the horizontal plane of the end point of the shoe shape/insole assembly in normal trim;

Contour Line D: this is a line described on the shoe shape by the top edge of the insole, i.e. giving the profile of the shoe welt, or in other words, the bottom seam when molding over the uppers;

Sole Height E: this is the thickness of the sole as measured at the middle of the plant rest line;

Heel Height F: this is the sum of the shoe shape height B and the sole height E (F=B+E);

Insole Thickness G: this is the thickness dimension of the insole and includes two measurements:
G′, being the thickness at the intersection with the main axis, and
G″, being the thickness at the stride line.

The method of this invention, comprising a sequence of steps that lead to developing, from a base shoe shape 2 of basic footwear size, a series of shoe shapes in a range of footwear sizes, will now be described.

In conformity with the French footwear size system presently in use, a so-called French size 21 or 22 is usually selected as a basic size for child footwear; size 37 or 38 for lady footwear; and size 41 or 42 for gentleman footwear. The need to use a multiplicity of base shoe shapes is explained, in fact, by the current development system showing departures that are the deeper the farther a shoe shape evolves from the base shoe shape.

The method of this invention comprises a first step of gathering data concerning the base shoe shape 2 of basic footwear size. The base shoe shape may be supplied, as is usual, by a shoe designer or a stylist using conventional techniques, or be an otherwise classical shape in the industry.

For all these alternatives, the method of this invention comprises a step of digitizing the base shoe shape of basic size.

More particularly, the surface 3 of the base shoe shape 2 of basic size is accurately gauged to obtain spatial coordinates x_{B}, y_{B} and z_{B} of each point P_{B} on that surface, using gauges and CAD means of data gathering.

In essence, a gauge 15 is run across the true surface 3 of the base shoe shape 2 along paths that allow the object to be accurately re-constructed. The gauge 15 is essentially a computer-controlled or manually operated mechanical type of gauge; alternatively, the physical surface 3 of the base shoe shape 2 could be laser scanned. The gauge 15 is controlled by the computer means to vary the reading intervals between areas of different criticality of the surface 3.

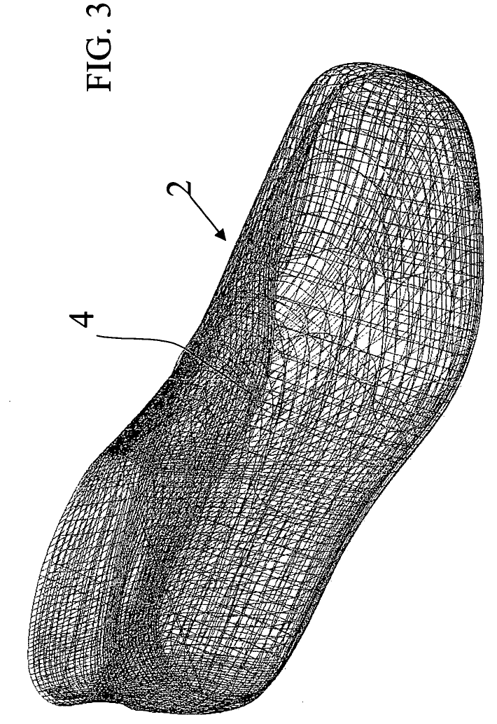

It is very important that the characterizing measurements and significant profiles taken from the base shoe shape be unsubject to the personal judgement of an operator. For this reason, the gauge 15 is arranged to be controlled by a computer means 10 running CAD simulation programs. The base shoe shape 2 of basic size is therefore digitized, or rather, reconstructed in digital form using a 3D data gathering technique, as shown in FIG. 3.

Preferably in the method of this invention, the surface 3 is contacted in a direct manner. In fact, data gathering by a mechanical gauge 15 is usually sufficiently precise, although more hardware and time intensive.

However, gauging selected regions of the real surface 3 can be adequate to digitally re-construct the surface, with no appreciable dimensional differences and with better regularity than by digitizing the whole surface.

As said before, optical systems could be used instead, although these are bound to introduce local distortion due to reflective and/or interference effects, which makes the surface reconstruction unavoidable.

In all cases, the outcome of this data gathering step is a data file that can be analyzed in a 3D CAD setting. The surface 3 of the base shoe shape 2 is re-constructed in digital form, and possible digitizing process errors can be corrected by the CAD program itself.

Methodical tests performed by the Applicant show that a true match of re-constructed surfaces 4 with the true surfaces 3 can be achieved.

Advantageously, the step of re-constructing the surface 3 of the base shoe shape 2 in a 3D CAD setting allows correspondence and compatibility with footwear manufacturing operations ahead of and after the method to be maintained. For example, during the data gathering step, the same contour lines as are traditionally used by shoe designers and the same sections as manually measured by them to physically produce the shoe shape according to traditional methods, can be tracked.

Of course, there is no reason why a base shoe shape 2 already available in digital form for CAD processing could not be used instead, as by retrieving the necessary data from some storage means set apart from the computer 10. However, this would involve changes to the ways of working of the shoe designers or the stylists of the base shoe shapes. The method of this invention allows instead the co-operation with the traditional stylist or shoe designer to be preserved, and the work to proceed along the same references as have been conventionally used in measuring base shoe shapes, but with an hitherto unknown degree of accuracy.

Once the base shoe shape 2 is re-constructed in digital form, the computer 10 will display on its screen 9 a virtual or simulated 3D surface 4, whereon each point P_{B} along its Cartesian spatial coordinates x_{B}, y_{B} and z_{B} can be exactly identified.

In essence, the design of a base shoe shape of basic footwear size according to the invention may be traditionally realized by a shoe designer or a stylist. Alternatively, a given shoe shape may be derived from an existing design duly processed through a CAD software.

In the former case, greater styling freedom is afforded, while in the latter, special features that are not to be forfeited and/or are distinctive of a manufacturer can be reproduced on a new shoe shape.

The re-constructed base shoe shape can be divided in three different surfaces: top, side and bottom surfaces 5, 6 and 7 that, once merged together, produce a three-dimensional object as shown in FIG. 1.

Each portion of the new shoe shape 1 is re-constructed by using a different technique that is specific to the CAD software employed and the type of surface of interest, and by using guidelines 13 that reproduce in digital form a manual template traditionally used by the shoe designer.

The guidelines 13 used for re-constructing a variety of shoe shapes may be suitably interpolated to produce a new shoe shape. This allows the manufacturer to maintain important elements on a number of shoe shapes and for several seasons.

For example, by storing the data about the guidelines 13 used to re-construct the shoe shape into a memory 8 incorporated to or associated with the computer means 10, a database of shoe shapes 1 can be created for later use in providing a new shoe shape with appropriate volumes, perhaps limited to a specified region thereof.

The CAD system makes substituting one or more guidelines 13 of a structure with corresponding guidelines 13 of another structure a comparatively easy task, thereby obtaining near-perfect morphing of both, as well as using a totally new style in some regions of a shoe shape, and maintaining its basic structure.

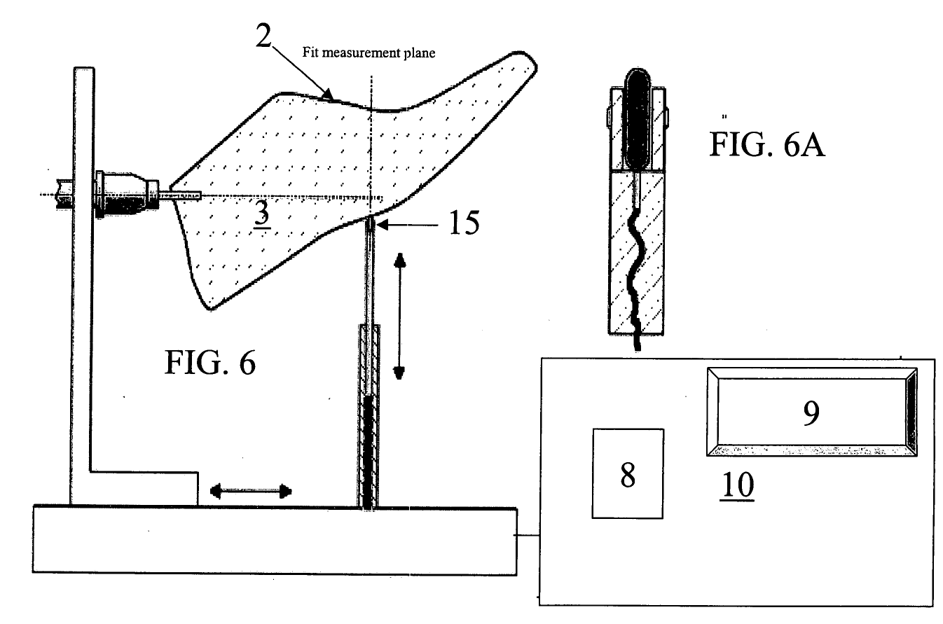

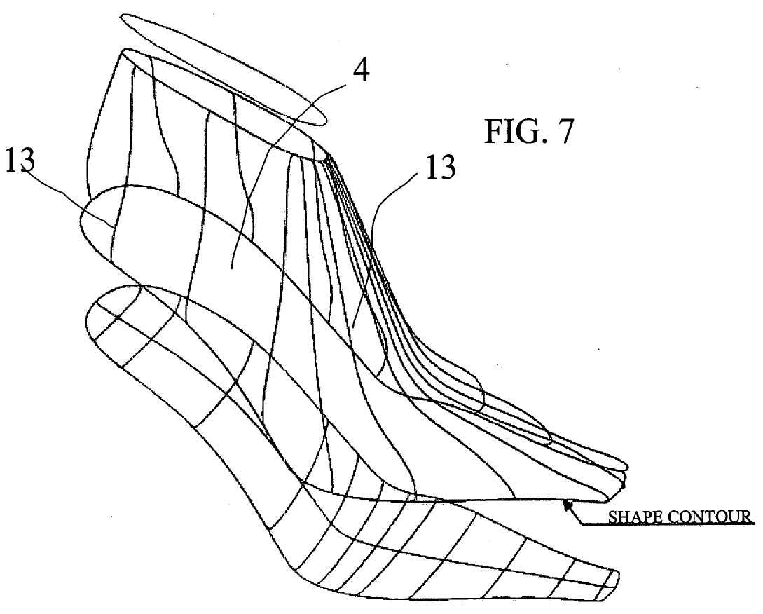

The construction guidelines shown in FIG. 7 are exemplary of the underlying principle that a surface 4 of the shoe shape 1 can be adequately described by the data of its construction lines, and that such data can be utilized by CAM machinery to perform certain machining operations on both the shoe shape 1 and the footwear article obtained therefrom.

Advantageously, this allows the length (X axis) and width (Y axis) real developments of the plant surface, as well as the shoe shape perimeter in its significant regions, such as the fit, instep, heel-to-metatarsus-to-tarsus ratio, heel height, stride, etc., to be also obtained.

In accordance with this invention, a novel footwear size measuring system, based on the metric system and expressed in cm at length increments of 0.5 cm, has been developed. Therefore, each footwear size is given as a number descriptive of length in cm (e.g., 20; 20.5; 21; and so on). The conversion factor to the French system is French Points*2/3=New Metric Size.

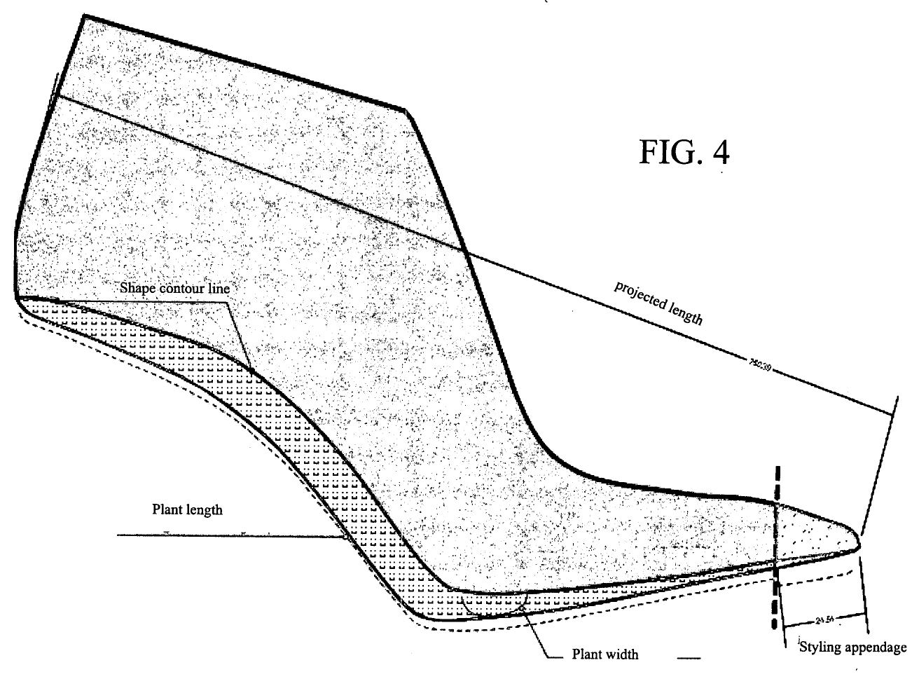

The length denoted by the footwear size is the length of the centerline of the shoe shape bottom surface. It is not a projected measurement as would be provided by a linear gauge, but a physiological length, i.e. a measurement of the distal extension of the footwear available for the foot, as shown in FIG. 4. The length increment of 5 mm for the footwear sizes refers to physiological length, but it proportionately increases if the shoe shape is provided with a styling attachment, as shown in FIG. 4.

Plant width is the length of a line bisecting the plant in its point of maximum extension. It is not the same as a measurement made at the same point with a linear gauge, the latter taking the projected length of the shoe shape, i.e. not being limited to just the bottom surface.

According to the theory of the human foot evolution that underlies the measurement system of the invention, once a discrete increment of 5 mm is set in the distal extension (x axis), the corresponding variations along the Y and Z axes are related to the distance of the size in question from the reference size.

In this respect, it is noteworthy that a constant increase of the foot length (x axis) correlates with a smaller increase in width and an even smaller one in thickness. In addition, the increases in width and thickness of the foot follow an arcuate shoe design, in relation to a constant rate of length increase.

Thus, the shape of the foot becomes more elongate as the length increases. Conversely, as the length decreases, the foot tends more towards plump proportions, and in the extreme, its right and left distinguishing features become hazy.

A size defines, therefore, the development of the foot plant surface in the distal direction, i.e. in the direction of its length, or along the X axis.

From the size number and a suffixed character, the width can be computed which represents the transverse development along the Y axis, and the fit of a so-called “regular” group. There are two more groups, however, referred to as “large” and “slim”, which differ by the fit dimension, and occasionally the width, for the same length.

It is noteworthy that a size does not represent the projection shoe shape length, nor the development of its bottom surface. A size rather indicates the space that the foot can occupy along the distal direction inside the shoe, less any styling appendages, as schematically shown in FIG. 5.

It will be appreciated that, in developing a real shoe shape, the same parameters must be applied to any styling appendages as well, thereby maintaining the proportions and style of the base shoe shape throughout the series.

The method of the invention is based on an anatomical evolution theory stated in the metric system, which theory has a reference in the physiological volume available for the foot and a related size system as described hereinabove. In essence, exact correspondence is maintained between the containing shoe and the contained foot as the size varies.

The volume of the shoe shape provides an excellent term for comparing different shoe shapes, in combination with the others described and the definitions given hereinabove. The volume increase going from one size to the next follows a non-linear law because the development parameters continually vary.

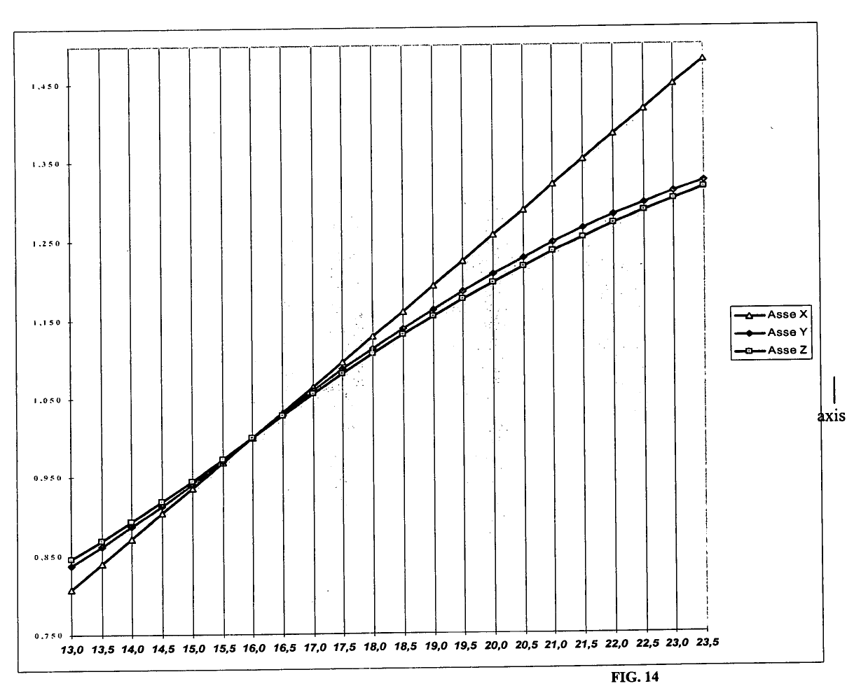

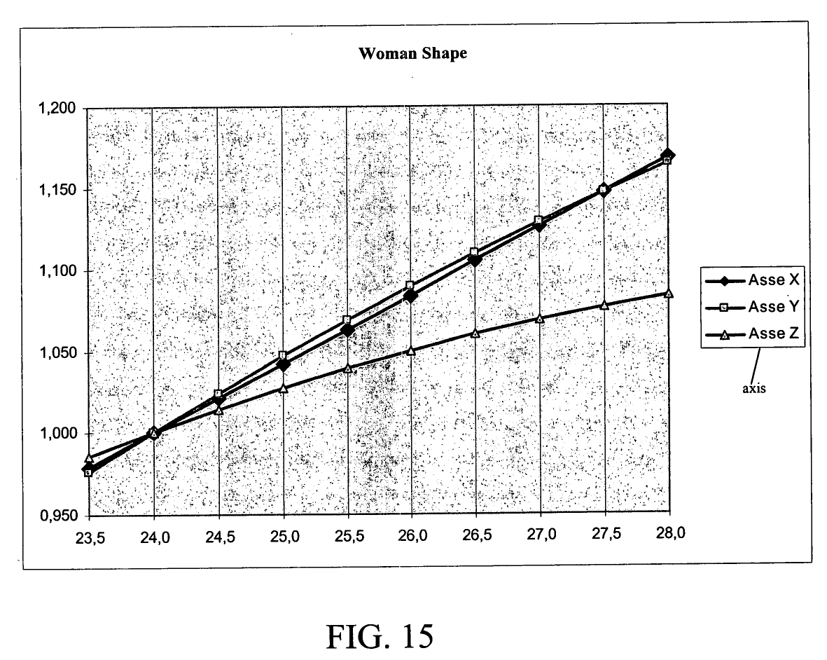

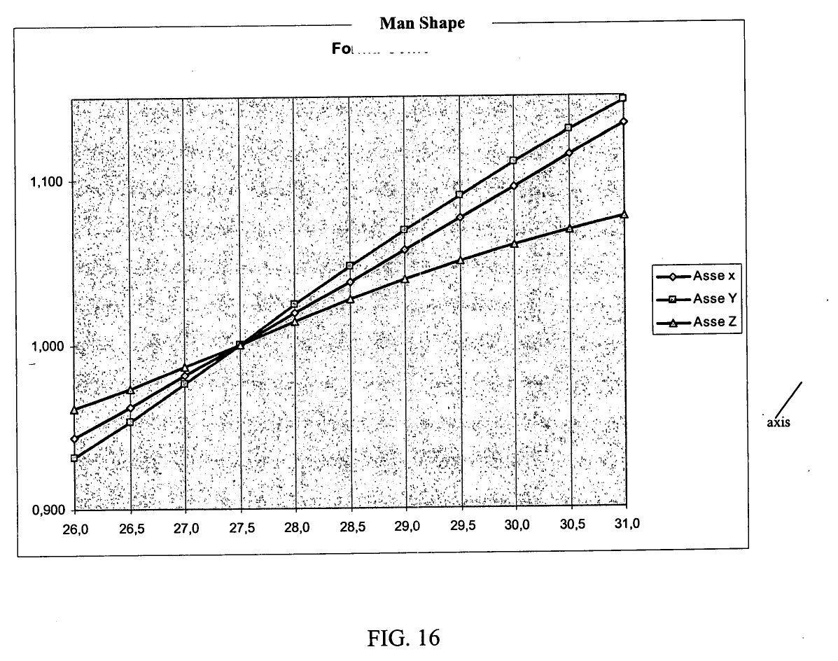

FIGS. 14, 15 and 16 are exemplary plots of the sizes (abscissa) and the differential variations (ordinate), illustrating the qualitative relationship and dimensional ratios of the measurements of shoe shapes that have been re-constructed according to the method of this invention along the X, Y and Z axes, for child, lady and gentleman shoe types, respectively.

The volumes of different shoe shapes of basic footwear size, less any styling attachments and the different height of the flat, are near equal even when the design differs substantially. This means that the foot has the same space available, even though the volumes may differ locally.

In this context, studies conducted by the Applicant have surprisingly shown that some classical rules of mechanical development currently employed to produce shoe shapes in a range of foot-wear sizes (so-called French sizes) lead to the degree of comfort degrading progressively. In fact, conventional methods use discrete length, width and fit increments, and practically produce an uncontrolled multiplication of shoe shapes, because they do not longer meet the requirements of the foot anatomical evolution.

The progressive degradation of a shoe shape character has been fought by manufacturers of shoe shapes with remedies that were suggested by independent experience. Such remedies were applied at the stage of scaling (developing) a shoe shape, and have eventually resulted in an uncontrolled production of shoe shapes that match the actual volume of the foot only in a few sizes. In essence, the need to have a number of different fits provided, which is so costly to the manufacturers, largely arises from a wrong choice of methods.

Advantageously in the method of this invention, to a shoe shape can be attributed a degree or mark of closeness to the real anatomy. This mark might be displayed as a degree or mark of comfort to the consumer, who would thus be able to make comparisons and then decide which is the best solution.

Of course, a comfort mark would only be of practical value if the measurements that underlie it are reliable. With the method of this invention, numerical values that are fundamental and characteristic of a given shoe shape can be found with great accuracy, and can be extended to a whole range of sizes of the shoe shapes.

These numerical values may be the volume available for the foot, the “fit”, and the softness of the materials of which the shoe is made out of. A standardized weighed sum in the measurement units allows a numerical mark to be obtained that is closely related to a given shoe shape and the ultimate shoe.

As an example, a measurement of “fit” will now be discussed which may be one of said values for computing the comfort marks to be granted to a shoe shape and/or displayed to a consumer in order to demonstrate the degree of closeness of the shoe shape to the foot anatomy. Fit is the narrowest region that the tarsus is to go through to “put on” the shoe.

The fit can be measured in a CAD setting by the following sequence of operations, illustrated by FIG. 5:

1. adjusting the trim of the shoe shape 1 with the Y axis to meet the centerline (Top);

2. adjusting the trim of the shoe shape 1 with the X and Z axes as references (Front);

3. drawing a diagonal line D from the end H of the contour line on the top pad to the foremost point K of the flat of a grip plate;

4. drawing some parallel lines Li to line D, at few millimeters spacings, in the fit region;

5. using lines Li to obtain sectional planes and sectional curves on the side and the lower surface, 6 and 7;

6. analyzing length to find the shortest length, obtaining any further sections until the selected one constitutes the point of reversal of the series; in particular, the lengths of the preceding and following sections are longer.

The section S thus found represents the fit, taken as the smallest section through which the tarsus and metatarsus are to be passed to put the shoe on.

By developing the shoe shapes on a computer means in a CAD setting, the range of sizes of the human foot can be reproduced true, such that the percent of users served by a specific design in the series can be kept constant.

The variations of points of the spatial co-ordinates for at least another shoe shape in the range of footwear sizes are obtained by using dynamic coefficients differentiated along each of the three Cartesian axes of the shoe shape development.

These coefficients are:

cₓ: a coefficient of development along X (length);

c_{y}: a coefficient of development along Y (width); and

c_{z}: a coefficient of development along Z (thickness).

An integer n will be used to indicate the positive or negative distance of a given footwear size from the basic size.

The coefficients cₓ, c_{y} and c_{z} are functions of n according to the following formulae:
Cx=1+f(n)
Cy=1+f(n)−f(·|n|)
Cz=1+f(n)−f(n |n|)

where, |n| is the absolute value of n.

Preferably, but not limited to, the above functions of the integer n are multiplication functions by predetermined numerical parameters (a, b, c, d, e), as per the following relations:
Cx=1+n·a
Cy=1+n·b−n·|n|·e
Cz=1+n·d−n·|n|·e

The numerical parameters a, b, c, d and e, which multiply the n term, may vary according to a manufacturer's own requirements, without this invalidating the method.

The values of c and e may differ from each other, but could be made to coincide instead.

In particular, these numerical parameters may vary within ranges of values as follows:

| | | |
|---|---|---|
| a | constant variation along X | (3.5 ÷ 1.5) · 10⁻² |
| b | 1st degree variation along Y | (3.5 ÷ 2.0) · 10⁻² |
| c | 2nd degree variation along Y | (4.0 ÷ 7.0) · 10⁻⁴ |
| d | 1st degree variation along Z | (3.0 ÷ 1.0) · 10⁻² |
| e | 2nd degree variation along Z | (4.0 ÷ 7.0) · 10⁻⁴ |

It should be noted that the coefficients of development from a child base shoe shape would be greatly different from those used for a gentleman base shoe shape, although the frame of the mathematical formula remains unchanged. In fact, in developing from a child base shoe shape, the frames of the formulae are the same, and only the numerical terms change, because the morphological evolution that is typical of the development is quite different from the simple scaling toward adult age.

The apparent complexity of the formulae is outbalanced by the advantage that charts giving absolute values along x, y and z for each size in the range are made unnecessary, while any shoe shape can be given the basic size property and be used as the starting reference for the development.

A set basic size will therefore maintain the style and peculiarities that mark the national footwear culture and the traditions of the individual brands, while by developing under new parameters, the same styling can be maintained through the whole series, such as was not feasible with mechanical development methods.

Let us see now the next step in the method of the invention.

In essence, once the spatial coordinates (xₙ, yₙ, zₙ) of the points on at least another shoe shape in the series are obtained from the spatial coordinates (x_{B}, y_{B}, z_{B}) of the points on the base shoe shape 2 of basic size, and using the calculation formulae set forth above, an NC tool machine can be fed with said spatial coordinates (xₙ, yₙ, zₙ) for manufacturing another shoe shape in the series.

The data about each size is entered to an NC machine, or a CAM device, where the several shoe shapes 1 are manufactured in a range of footwear sizes.

The shoe shape 1 of each size is then used on traditional lathe equipments to produce 1:1 mirror-image copies.

In addition, and still in a 3D CAD setting, the contours and volumes of the necessary component parts, such as insole, sole, quarter, heel, etc., are set and their lines are drawn directly onto the surface of the virtual shoe shape.

The molds for manufacturing the various component parts, e.g. a mold for the insole, one for the heel and the sole, and the molds for thermoforming the toe piece and the quarters, are also designed.

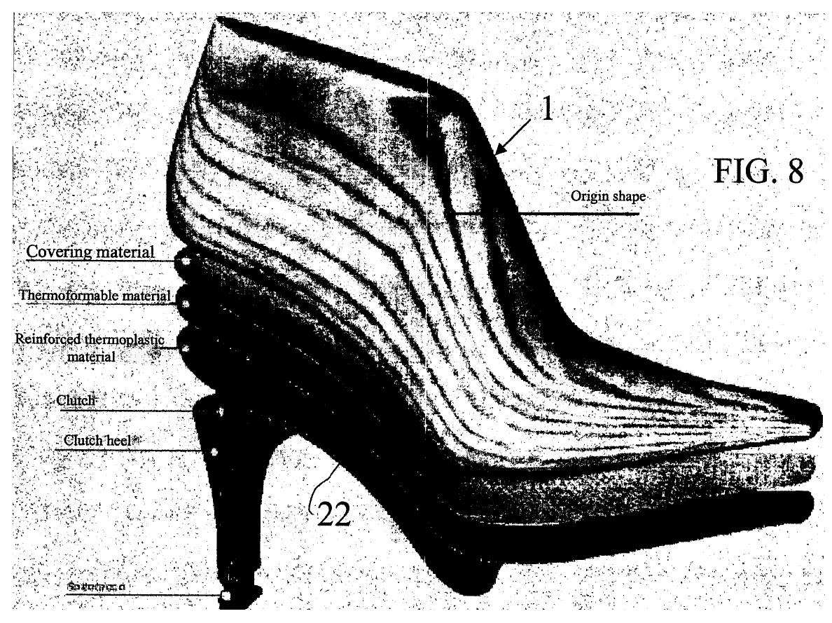

The resulting shoe shape 1 is placed onto a module 23 of an automated assembly line 24 that is driven stepwise, as shown in FIG. 9A.

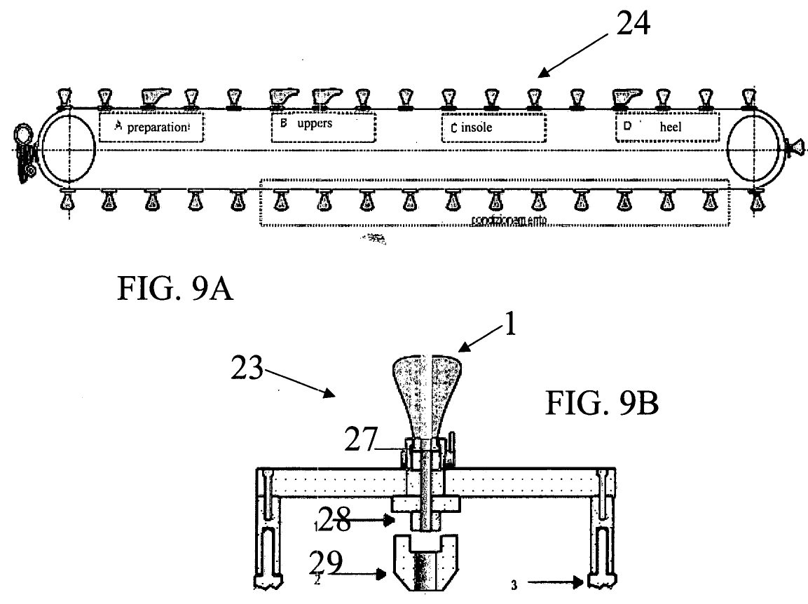

A bi-axial manipulator 20, shown in FIG. 10, takes the appropriate insole 22 from a magazine 26 by means of a suction cup pickup 19 and places it exactly onto the plant of the shoe shape 1, which is provided with a suitable hold plate 27 and a hold 28.

The open uppers 15 is manually positioned and secured at a required height on the rear of the heel 14; at this stage, the shoe shape 1 is released from its holder.

A second tri-axial manipulator 25, whose axes are integrated to the pivot axis of the line, dispenses a bead of a thermoplastic adhesive onto areas of the insole 22 and the uppers 15, and directly adheres the latter together.

The area where a sole 18 is next to be glued is dressed by the bi-axial manipulator 20, whose axes are integrated to the third pivot axis of the module of the line 26.

Another bi-axial manipulator picks up the appropriate heel 23 and press fits it into the top pad 16 of the insole 22. A short HF pulse, or another suitable means, will join both plastics parts together at their interface.

Powder adhesive is sprinkled and fixed to the surface of the assembled shoe shape 1 and the sole 18.

After heating the surfaces locally, the sole 18 is pressed onto the shoe shape 1 by the tri-axial manipulator 25.

According to the invention, the shoe shape 1 is provided with a group of data and/or instructions that can be read by tool machines and make the manufacture of the shoe shape 1 and the shoes produced with it much more accurate and versatile, while greatly reducing the number of manual finishing and assembling operations.

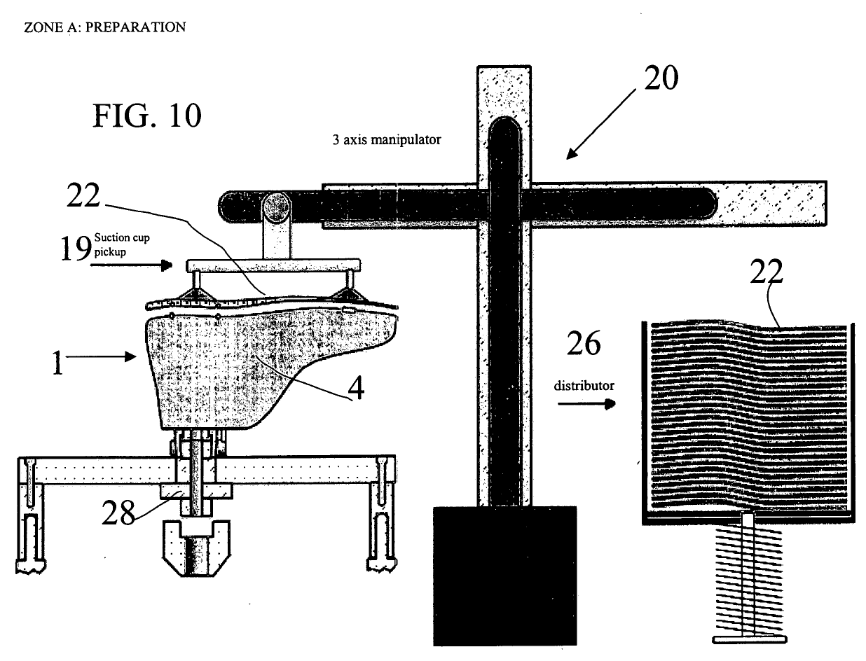

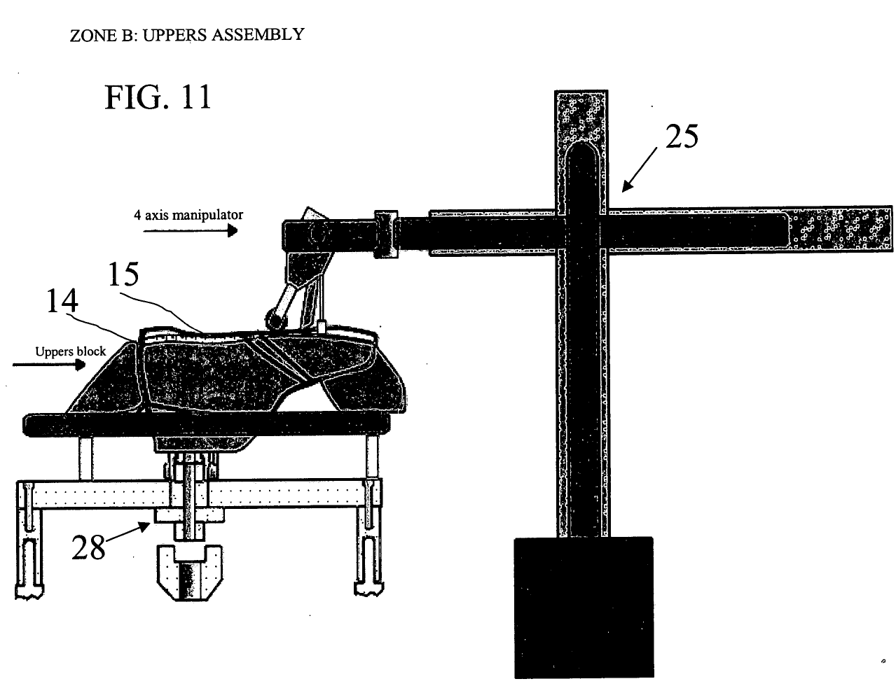

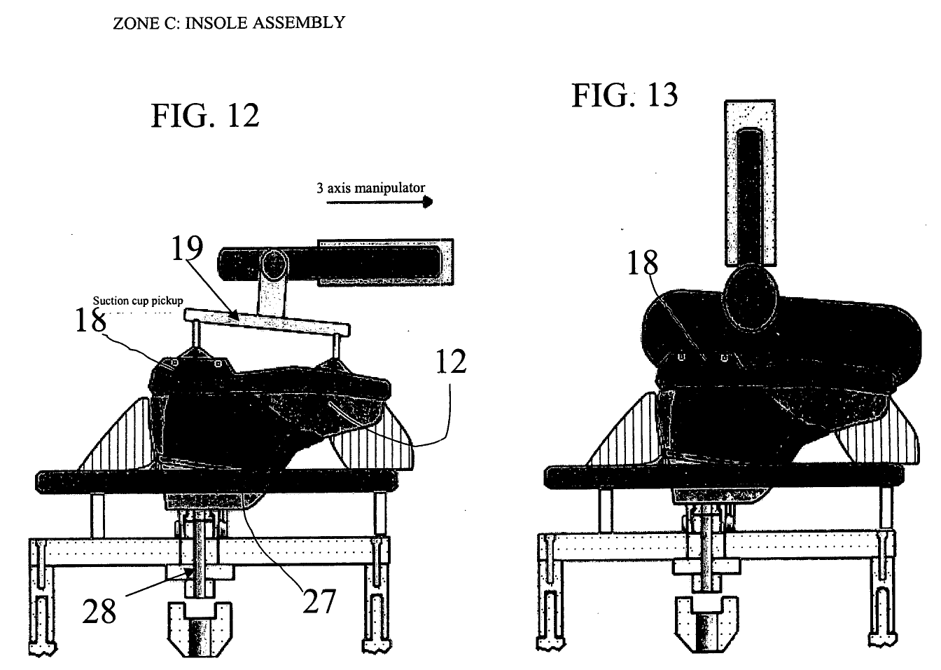

For this purpose, an integrated electronic circuit 30 is placed into the shoe shape 1 after the tool machine has dressed the top surface 4 of the turned shoe shapes 1 and before the hold plate 27 is mounted, as shown in FIGS. 10 to 13.

The circuit 30 may be a read/write memory or a read-only memory, e.g. a ROM, PROM, EPROM, EEPROM, or RAM.

A seat 31 (to be shown) for the integrated circuit 30 is formed in the dressed top face of the shoe shape 1. From here onwards, the shoe shape will only be manipulated using the hold 27, which ensures its exact positioning during the selvedge trim-off step and optional finishing and checking steps.

The group of data and instructions can be written and used several times, even on the same shoe shape, to obtain a smaller shoe shape and save substantially in material and power. The circuit 30 contains data concerning the records of the factory where the template for the shoe shape has been produced, an identification code, and CAM instructions that describe the path of the contour line with respect to a position or zero reference.

As previously explained in relation to FIGS. 4 and 7, the contour line is a continuous line separating the side surface 6 from the bottom surface 7. It may be drawn on the real shoe shape and digitized, or obtained directly on the digital surface 4.

The trace of this line, or derivatives thereof, is used for various processing operations, such as trimming the selvedge off the shoe shape being constructed, designing the molds for the bottoms and the other component parts, grinding the uppers, etc.

This trace will be contained in the circuit 30 provided in the shoe shape 1, along with a code for accessing the construction records, whose data is available for more complex processing operations, such as positioning the component parts, assembling, applying the bottom, etc.

The comfort rating mark previously described may also be among the data stored in the storage chip 30.

Advantageously, the data stored in the chip 30 is read contact-less, by radio or magnetic transmission within a range of twenty to eighty cm, it being unnecessary to touch the shoe shape.

This technique allows the “smart” shoe shape to be fully utilized at a relatively low cost and without releasing constructional data. In essence, the factory's need to inhibit copying the shoe shape construction data is maintained, because the access code is referred to confidential records.

This innovation allows more generic, and hence more flexible, tool machines for shoe manufacturing to be designed to serve a fully automated pallet assembly line.

The manipulators are low in complexity and specificity, since it is the shoe shape itself that provides them with part of the processing instructions.

The modest increase in shoe shape cost is amply outbalanced by the suppression of downtime for adjustment, the drastic reduction in the number of shoe shapes needed on the production line, and the reduced labor cost, manpower being only required for overseeing purposes.

Based on the CAD data used for manufacturing the shoe shape 1, designing and/or making the component parts for the shoe shape and the shoe is relatively simple. In fact, some CAM tools dedicated to cutting the uppers component parts, the digital surface of the shoe shape provides an excellent substrate for fashioning the toe piece and quarter, which can be cut directly on CAM machines for small production volumes.

The bottom surface of the shoe shape 1 provides the starting point for designing the reinforcing insole, with the heel and/or the sole.

Manufacturing the molds for the reinforcing core of the insole and the sole creates problems neither in the respect of directly machining the metal block nor in the respect of making the resin shoe design and the subsequent aluminum casting onto the plaster copy. This second course introduces, however, a degree of approximation, due to the dimensional settling of the casting being unpredictable. This may be unacceptable in some cases, or require a pass under an NC grinder.

In most applications that require polyurethane bottoms, this production course leads to much better precision than is normal, without excessively upsetting the mold manufacturing technique and cost.

It is the shoe manufacturer that supplies the mold maker with the shoe designs for all the sizes, produced on an NC tool machine, and therefore dimensionally faultless, from which the casting molds will be obtained.

The small shoe manufacturer may request the assistance of a business firm or the mold manufacturer to have the shoe designs designed and prepared at a comparable costs with that of manufacturing a traditional set of shoe designs.

To summarize, by developing the shoe shapes in the CAD form, the component parts can be manufactured using parallel working criteria. Likewise, it will be appreciated that design facilities can be established in places other than those where the molds, equipment and even the end product will be made.

According to this invention, the shoe shape has become, from the simple substrate it used to be, instrumental to a good qualitative level, because the shoe shape itself supplies part of the information for processing the footwear article. Thus, the assembly line is revolutionized and turned into an integrated transfer, with a pivot axis that interacts with the traditional axes of less dedicated machines requiring each time adaptation for changing machining operations.

By having a whole range of shoe shapes represented digitally in a full range of sizes, a shoe manufacturer can order from respective suppliers footwear component parts that are integrated together, and be assured of their perfect compatibility. All this without having to go through a long serial process of adjusting one component part at a time, which process frequently results today in significant alterations of the shoe shape structure, destructive of all correspondence of the shoe shape with the foot.

Major advantages of the method of this invention for manufacturing shoe shapes and all the component parts that are integrated to it, are:
reduced need to manufacture a design for different fits;
all the component parts designed match perfectly;
automated shoe shape production cycle, with reduced manual work requirements;
consistent long-term reproducibility;
easy combination of different lines;
batch development made feasible, with substantial savings in component parts;
different fits can be produced economically, with the plant kept unchanged;
elimination of fastenings, as a result of using an integrated insole;
designing can be dislocated with respect to production;
protected construction data: a shoe shape can only be made as a copy;
automated shoe production cycle, reducing manual work costs.

1. A method for scale manufacturing a series of shoe shapes distributed on a series of footwear sizes starting from a base shoe shape (2) provided in a basic footwear size, comprising the following steps:
gathering the spatial coordinates (x_{B}, y_{B}, z_{B}) of points on the base shoe shape (2) of basic size using gauges (15) associated with a first computer means (10) on which CAD programs are run, or obtaining said spatial coordinates (x_{B}, y_{B}, z_{B}) from a storage unit (8);
obtaining, from the spatial coordinates (x_{B}, y_{B}, z_{B}) of points on the base shoe shape (2) of basic size, the spatial coordinates (xₙ, yₙ, zₙ) of points on at least another shoe shape in the series, by using said computer means (10) provided with predetermined calculation formulae;
feeding an NC tool machine with said spatial coordinates (xₙ, yₙ, zₙ) of points on said at least another shoe shape in the series for the manufacture thereof;
characterized in that said computer means (10) equipped with CAD programs is used for defining the profile, the volume, or the spatial coordinates of footwear component parts associated with said another shoe shape in the series;
and that said coefficients (cₓ, c_{y}, c_{z}) are functions of an integer (n) denoting the positive or negative distance of a given size in the range with respect to the basic size, according to the following formulae:
Cx=1+f(n)
Cy=1+f(n)−f(n·|n|)
Cz=1+f(n)−f(n·|n|)
where, |n| is the absolute value of n.

2. Method according to claim 1, characterized in that said functions of said integer (n) are multiplication functions by predetermined numerical parameters (a, b, c, d, e), as per the following relations:
Cx=1+n·a
Cy=1+n·b−n·|n|·c
Cz=1+n·d−n·|n|·e

3. Method according to claim 2, characterized in that the parameter (a) of constant length variation along the X axis varies within the range of (3.5÷1.5)·10⁻².

4. Method according to claim 2, characterized in that the parameter (b) of first-degree width variation along the Y axis varies within the range of (3.5÷2.0)·10⁻².

5. Method according to claim 2, characterized in that the parameter (d) of first-degree thickness variation along the Z axis varies within the range of (3.0÷1.0)·10⁻².

6. Method according to claim 2, characterized in that the parameter (c) of second-degree width variation along the Y axis varies within the range of (4.0÷7.0)·10⁻⁴.

7. Method according to claim 2, characterized in that the parameter (e) of second-degree thickness variation along the Z axis varies within the range of (4.0÷7.0)·10⁻⁴.

8. Method according to claim 2, characterized in that the values of said parameters (a, b, c, d, e) are increased to develop shoe shapes for child sizes from those for developing lady/gentleman shoe shapes.

9. Method according to claim 2, characterized in that said second-degree variation parameters (c, e) along the Z axis may have the same value.

10. Method according to claim 1, characterized in that said range of footwear sizes spreads over constant-rate length variations (X axis), and over width (Y axis) and thickness (Z axis) variations that are related to said length variation.

11. Method according to claim 10, characterized in that said constant rate is equal to 0.5 cm.

12. Method according to claim 10, characterized in that a size in said range of footwear sizes describes the foot plantar surface as developed in the distal direction, i.e. in the length direction or X axis.

13. Method according to claim 1, characterized in that the footwear sizes are spread over length variations that are based on the decimal metric system.

14. Method according to claim 1, characterized in that a comfort rating mark, obtained from said computer means (10) as a sum, that is weighed and standardized in respect of the measurement units, of a group of numerical values characterizing a given shoe shape, is associated with each shoe shape in the series.

15. Method according to claim 14, characterized in that said numerical values include at least the volume available for the foot, the “fit”, and the softness of the materials out of which the shoe is made.

16. Method according to claim 15, characterized in that the fit is the smallest section through which the tarsus and the metatarsus must be passed in order to put on the shoe, as calculated in a parallel plane to a diagonal line (D) from the end (H) of the contour line on the top pad to the foremost point (K) of the top flat of the shoe shape (1).

17. Method according to claim 1, characterized in that said footwear component parts are at least the insole, the sole, the quarter, and the heel.

18. Method according to claim 1, characterized in that the data about the spatial coordinates (xₙ, yₙ, zₙ) of points of all the sizes in the range, as well as about said component parts associated with each shoe shape, is contained in a storage unit (8) associated with said computer means (10).

19. Method according to claim 18, characterized in that said storage unit (8) contains a database.

20. Method according to claim 18, characterized in that a part of the data is contained in an integrated circuit (30) placed in the shoe shape (1).

21. Method according to claim 1, characterized in that said component parts are realized by feeding tool machines with data about the profile, the volume, or the spatial coordinates of said footwear component parts.

22. Method according to claim 1, characterized in that said tool machine incorporates and is driven by an on-board computer means corresponding to said computer means (10).

23. Method according to claim 16, characterized in that said storage unit is a read/write memory or a read-only memory.

24. Method according to claim 1, characterized in that said calculation formulae link the spatial coordinates (xₙ, yₙ, zₙ) of points on said at least another shoe shape in the series to the spatial coordinates (x_{B}, y_{B}, z_{B}) of points on the base shoe shape (2) by a relation of proportionality of predetermined coefficients (cₓ, c_{y}, c_{z}).

25. Method according to claim 1, further comprising the steps of:
obtaining from said spatial co-ordinates (x_{B}, y_{B}, z_{B}) of the base shoe shape (2) the spatial co-ordinates (xₙ, yₙ, zₙ) of points of some shoe components corresponding to said at least another shoe shape in the range;
feeding an NC tool machine with the spatial co-ordinates of said shoe components (8,11,12), for manufacturing respective moulds of said components;
molding the respective components.

26. A shoe shape of a predetermined footwear size for manufacturing footwear in very large scales by automatic assembly machines, characterized in that it incorporates an integrated electronic circuit (30) containing data about the spatial coordinates (xₙ, yₙ, zₙ) of points on the shoe shapes of said predetermined size in the series, and about footwear component parts associated with said shoe shape.

27. Shoe shape according to claim 26, characterized in that said integrated circuit (30) is received in a suitably provided socket (31) on the flat top surface of said shoe shape (1).

28. Shoe shape according to claim 26, characterized in that said integrated circuit (30) is either a read-only memory or a read/write memory.

29. Shoe shape according to claim 26, characterized in that data and information about the records of the shoe shape manufacturer where the shoe shape shoe design (1) has been made, an identification code, and CAM instructions describing the path of the contour line relative to a position reference, are stored in said electronic circuit (30).

30. Shoe shape according to claim 26, characterized in that the data contained in said electronic circuit (30) is read contact-less by radio or magnetic transmission.
